(19) United States
(12) Patent Application Publication
(10) Pub. No.: US 2014/0156791 A1
(43) Pub. Date: Jun. 5, 2014

(54) A MICROPROCESSOR BASED SYSTEM FOR PROVIDING A MEDIA PLAYER WITH ACCESS TO REMOTELY-STORED DIGITAL MEDIA CONTENT

(71) Applicants: Philip Anthony Sant, London (GB); Mark Stephen Knight, London (GB); Simon Black, London (GB)

(72) Inventors: Philip Anthony Sant, London (GB); Mark Stephen Knight, London (GB); Simon Black, London (GB)

(73) Assignee: OMNIFONE LTD., London (GB)

(21) Appl. No.: 14/008,829

(22) PCT Filed: Apr. 2, 2012
(86) PCT No.: PCT/GB2012/050740

§ 371 Date: Feb. 10, 2014

(30) Foreign Application Priority Data
Apr. 1, 2011 (GB) 1105573.8

(51) Int. Cl. H04L 12/24

(52) U.S. Cl. CPC H04L 41/509
USPC 709/217

(57) ABSTRACT

A microprocessor based system provides a media player with access to remotely-stored digital media content and/or its associated metadata. The system is capable of accessing the content, so that the media player is provided, by the system, with a suitable interface, accessible by that media player, for interacting with the content. The system may be packaged as a USB memory stick and can be inserted into, for example, a PC running a legacy media player with no intrinsic ability to access remotely stored content. The PC can in this way be enabled to access the remote content.

### BACKGROUND OF THE INVENTION

1. Field of the Invention

A method for providing a device, whether network-connected or not, with access to remotely-stored digital media content as if that digital media content were contained on storage accessible to the device via any suitable interface accessible by that device.

2. Description of the Prior Art

One major historical problem with regard to accessing digital media content is that many pre-existing media player devices are not connectable to an online service, and so are restricted to playing only content which is physically present in the form of, for example, a CD or DVD.

Traditionally, this problem has been addressed—but not solved—by providing a mechanism to “side load” content to the media player device. That is, to use a home computer's network connection to download digital media content and then to transfer that content to the media player device via a wired or wireless connection. Such a “solution”, however, only allows the device to access that content which was previously side-loaded, rather than facilitating the searching, browsing or downloading of digital media content “on the move” from a catalogue from the device itself. As such, it provides only a disjointed and unsatisfying experience for the end user.

However, the present invention combines the provision of network connectivity, via an implementation of the invention called the ‘CloudStick’, as disclosed below, with digital media catalogue access and thereby solves that problem and allows any device with a suitable connection—such as a USB port or a Smart Card slot, a HDMI cable, DLNA capability or a coaxial aerial connection—to have immediate access to the entirety of a remotely stored digital media catalogue.

A second historical issue is that of DRM-protected media content being tied to a small number of devices. For example, the terms of use for a particular media file may enable it to be playable on a user's home computer and MP3 player but not on their in-car media player. In its swappable version, the present invention may contain its DRM requirements internally (for example tied to the CloudStick rather than to the specific device which is used to play back the media content) and thus resolve that historical issue by enabling the user to simply connect their CloudStick to any suitable media player at will.

A third historical issue has been the problem of how to provide a media playback device with access to a digital media catalogue of any significant size without major reengineering of that playback device, in terms either of hardware or of software or both.

The problem has historically been that such “legacy” media playback devices either have little to no connectivity or require that such connectivity be integrated into the device's hardware and/or software. The present invention removes any such obstacles by presenting such devices with an appropriate interface, as disclosed in some detail herein, and encapsulating all connectivity and/or DRM management issues within the CloudStick itself. Thus, the “legacy” playback device is able to access a remote media catalogue without requiring any reengineering of its own hardware or software.

The present invention, CloudStick, builds upon some prior art building blocks, most significantly the hardware interfaces utilised in the preferred embodiment and the variations thereof, particularly the integration of processing chips with such interfaces (e.g. USB drives which incorporate a central processing unit and SD cards which utilise wifi to transfer data to Network Attached Storage devices).

Such prior art is utilised within the present invention, but significantly built upon and majorly expanded—both by way of the CloudStick Agent (see below) and the associated dynamic interface to the device which it makes possible and by the further integration of network connectivity within the CloudStick device, such aspects and others being as disclosed below—to produce a novel solution to the abovementioned historical problems.

### BRIEF SUMMARY OF THE INVENTION

The present invention is a system for providing a device access to a digital media catalogue. The system is a microprocessor based system for providing a media player with access to remotely-stored digital media content and/or its associated metadata (collectively, the “content”) whereby (a) the system is capable of accessing the content; (b) the media player is provided, by the system, with a suitable interface, accessible by that media player, for interacting with the content.

One implementation of the system is called ‘Cloudstick’. CloudStick encapsulates one or more of the following components:
A connection between the CloudStick and the media player device.
A connection between the CloudStick and the digital media catalogue.
Storage, to hold digital media content (and associated files, such as DRM keys and licenses).
The CloudStick Agent, which is a software component which manages the connections between the digital media catalogue and the device such that the device views the digital media catalogue via whatever interface is required by the device. In one example embodiment, the CloudStick acts as a proxy between the device and the online digital media catalogue. In the preferred embodiment, the CloudStick acts as a protocol mediating proxy for the device, with the capability of streaming digital media content which providing the device with a view of that stream as if it were a locally-stored file.
A digital media player, whether resident on the device or on the CloudStick.

Other optional features include the following:
the media player is connected to a network, the media player is not connected to a network or the media player is intermittently connected to a network.
the suitable interface presented to the media player consists of one or more of the following, or some combination thereof: a USB connection, and related technologies, such as mini-USB and micro-USB connections of whatever version, whether or not presented as a Mass Storage Interface to the media player; a Wireless USB connection; a Secure Digital card connection or similar technology, such as an SDHC card, a MicroSD card, a MiniSD card, a Memory Stick or an SDIO (Secure Digital Input/Output) card; a wireless connection to the media player, utilising WiFi, BlueTooth, a Wireless LAN or other wireless connections; an Ethernet cable; an eSATA connection; a mobile media player connection such as an iPod™ or iPhone™ hub or any other appropriate connection; a DLNA (Digital Living Network Alliance) capable interface; a DVI (Digital Video Interface) connection; a HDMI (High-Definition Multimedia Interface) connection; an infra-red or other non-visible light based interface; an IEEE 1394 (“FireWire™”, “i.Link™”, “Lynx™) interface; a smart card connection, such as an RFID interface or related wired or wireless technologies; any NFC (Near Field Communication) technologies, such as an RFID interface or related wireless technologies; any other mechanism which may be used to provide a communications facility between the system and the media player.
the suitable interface presented to the media player includes a coaxial aerial connector or an audio input terminal or any other suitable connection, whether analogue or digital.
the selection as to which interface(s) to present to the media player is made manually.
the selection as to which interface(s) to present to the media player is made automatically based on the capabilities of the media player—whether those capabilities are detected by the system or retrieved via a lookup of the media player's capabilities based on identifying information about the media player, however obtained or retrieved—or by any other suitable criteria.
the system accesses the content via one or more of: a direct connection, a wireless connection, such as wifi; a wireless network; a mobile network; an internet connection; 2G, 2.5G, 3G, 4G, EDGE, Wifi, wireless LAN access, Bluetooth, 802.11a/b/g, LTE (3GPP Long Term Evolution), LTE Advanced or any mechanism which provides communications via any other wired or wireless communications protocol or method.
the selection as to which method of connectivity to use by the system to access the content is determined manually.
the selection as to which method of connectivity to use by the system to access the content is determined automatically based on connection strength, tariff costs, location, connection speed or by any other suitable criteria.
the system houses or otherwise utilises one or more active SIM (Subscriber Identity Module) cards to permit the system to authenticate to a mobile network and so make use of the MNO's (Mobile Network Operator) data connectivity.
the system houses or utilises multiple SIM cards and switches between different mobile network operators, whether that switching is performed manually, at user instigation or automatically, based on location, tariffs or any other considerations.
interacting with the content (which term includes any associated metadata) includes one or more of: searching the content; browsing the content; retrieving the content; playing the content using the media player; making the content available for playback by any other capable media player; or any other suitable manner of interacting with the content.
the content is made available via a digital media content subscription service AND the system is capable of registering or logging into that service if required.
the system accesses and/or maintains subscription information and/or digital media content entitlements for the user or users of the system with regard to the service or services with which the system is registered and/or connected to.
the associated metadata includes one or more of: the title(s), artist(s), composer(s), genre(s), style(s) of items of digital media content; any files, keys or information required to access items of digital media content, whether protected by DRM technology or not, as required; playlists or any other groupings of digital media content; any other metadata related to items of digital media content or groupings thereof.
the associated metadata includes in addition of one or more of the following: user profiles, messages, recommendations, social network-related data or functionality, album listings, movie details, television schedules, theatrical listings, news, the making and obtaining of recommendations and/or playlists and any other data made available due to the system's connectivity and/or accessible to the system via a service.
the system allow synchronisation, whether manual or automatic, between the user's preferences and/or any other associated metadata on the system and in the digital media catalogue.
the online connectivity provided by the system is made available to the media player and/or to the system for other purposes, such as social networking functions and web browsing, whether generally or only to specifically authorised applications.
the system contains a protected and/or encrypted store, used to hold one or more of: DRM licences and keys, system configuration settings, system registration details, system bindings, digital media catalogue licensing or subscription files and any other files which are deemed either to be sensitive as to their content or non-useful to be visible to the end user or which are stored in that protected store for any other reason.
the system uses its network connectivity to download, progressively download and/or stream the content.
the system acts as a proxy or a protocol mediation proxy between one or more online digital media collections and the media player to which the system is connected.
content—including digital media content, any associated metadata, social networking data or any other retrieved data, as required—is cached for future use, whether cached directly on the system or on some suitable alternative, such as Network Attached Storage or the media player.
cached data is used to provide the system with access to content and/or associated metadata when “offline” (when online connectivity is unavailable), such as when travelling on some planes and underground railways or when connectivity is disabled, whether manually or automatically.
the system intelligently reclaims storage space by identifying that content which was least-recently accessed/played and/or which the user (or his/her associated community, whether via social network rating or otherwise) has rated as being least popular and then deleting, archiving (moving to a separate storage system) or overwriting such media in order to utilise its storage space for more recently requested metadata or files.
the media player communicates with the system via an Application Programming Interface (API) provided by the system to the media player for that purpose.
the API provided by the system to the media player allows the media player to interact with a remote digital media content catalogue and/or a service via the system.
the API provided by the system to the player mimics file system operations undertaken by the media player, including but not limited to a search by the media player of what appears to the media player to be a local file system being managed by the system as a remote search of a digital media catalogue, with the search results presented by the system to the media player in a form consonant with the media player's capabilities, such as by providing the media player with a virtual file system containing the search results or placeholders thereof or by any other appropriate means.
the system performs protocol mediation such that media content may be downloaded or streamed to the system from a remote server but presented to the media player as if it were a locally stored file.
the system permits content to be broadcast to one or more suitable media players, whether connected directly or wirelessly, including but not limited to broadcasting to one or more DLNA-capable media players.
the system is capable of communicating, directly or wirelessly or by any other appropriate means, with other systems and/or media players to permit sharing of content, including associated metadata; shared caching of content; or for any other suitable purpose.
the system scans and/or identifies any digital media content stored on the media player and/or the system and uploads that content or descriptors thereof to one or more remote servers from which that content may be made available to the user's other registered systems and/or media players.
the system incorporates location tracking technology, such as GPS (Global Positioning System), to assist in providing one or more of the following functions: determining which locale-specific digital media catalogue is to be accessed; obtaining access to that catalogue if desired; to automatically, or on request, purchase or otherwise obtain access rights to that catalogue; perform social networking functions; or for any other suitable purpose.
the system functions as a removable or Network Attached storage system and/or interfaces with other such storage systems.
the architecture of the system and/or its controlling software is modular in nature AND may be updated and/or expanded or contracted based on manual or automatic directives, whether initiated manually, automatically by the system or remotely by any suitably authorised service.
the system is adapted to interface with the media player, in which the media player is one or more of the following, or any combination thereof: a computing system; a digital media player; an analogue media player or any system capable of browsing, storing or playing digital and/or analogue media content.
the system is adapted to interface with the media player, in which the media player is a desktop system, such as a computing system, a hi-fi system, a turntable, a television, a games console or any other non-portable system.
the system is adapted to interface with the media player, in which the media player is a portable system, such as an mp3 player, an in-vehicular entertainment system or a handset or any other portable or mobile system.
the system is adapted to interface with the media player, in which the media player is wholly or partially integrated into the system and provides zero, one or more of: connection socket(s) for headphones; a battery; a battery charging mechanism; a screen to display information to the end-user and/or to display images, text and/or video or any combination thereof; operating controls for an on-system media player; remote controls for an on-system media player; facilities for searching, browsing and/or otherwise interacting with a remote digital media content catalogue and/or service; any other suitable provisions.
the system is a portable, personal device.
the system microprocessor is not dedicated to the system but used by other processes or modules that are unrelated to the system.
the system is self-contained in so far as it has own dedicated microprocessor and operating system.
the system is adapted to operate with the media player, in which the media player has no intrinsic ability to access remotely stored content.
the system is adapted to operate with the media player, in which the media player has no intrinsic ability to access remotely stored content and is a legacy third party media player.
the system is packaged as a USB memory stick.

### BRIEF DESCRIPTION OF THE FIGURES

FIG. 1: Basic CloudStick architecture

FIG. 2: An example embodiment of the Basic System Architecture

FIG. 3: The Cloud to CloudStick to Device Interfaces

FIG. 4: Examples of Functional Variations of File System Interface by Device/Access Type

### DETAILED DESCRIPTION

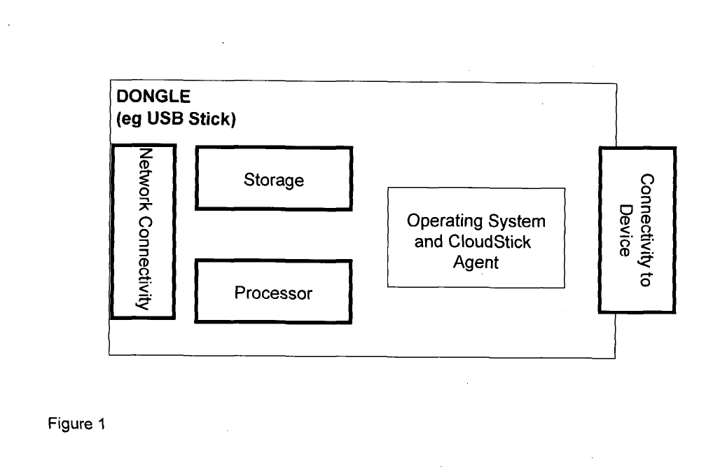

FIG. 1: Basic CloudStick Architecture

FIG. 1 illustrates the basic architecture of the CloudStick which, in this example embodiment, comprised network connectivity, to provide the CloudStick with access to the digital media catalogue on a remote server; Connectivity to the Device, to permit the device to access the digital media content retrieved from the catalogue by the CloudStick; Some storage facility, to store digital media content and any associated files, whether permanently or transiently; and an on-CloudStick processor and the CloudStick Agent, which manages the connections between the CloudStick and both the digital media catalogue and the device, providing the device with an interface to that content using whichever mechanism is appropriate for that device.

In the preferred embodiment, the CloudStick Agent also serves additional functions, as disclosed later in this document.

In the preferred embodiment, the CloudStick is a portable consumer electronics device which is capable of being very small, but not necessarily so. In one example embodiment, the CloudStick is integrated into another device, such as a mobile phone, a home computer, a laptop, a media player, an IVE (In-Vehicular Entertainment system) or any other device. In the preferred embodiment, the CloudStick is a self-contained mechanism which is connectable to one or more devices, including but not limited to those enumerated above and/or to other CloudSticks.

### DEFINITIONS

For convenience, and to avoid needless repetition, the terms “music” and “media content” in this document are to be taken to encompass all “media content” which is in digital form or which it is possible to convert to digital form—including but not limited to books, magazines, newspapers and other periodicals, video in the form of digital video, motion pictures, television shows (as series, as seasons and as individual episodes), computer games and other interactive media, images (photographic or otherwise) and music.

Similarly, the term “track” indicates a specific item of media content, whether that be a song, a television show, an eBook or portion thereof, a computer game or any other discreet item of media content.

The terms “playlist” and “album” are used interchangeably to indicate collections of “tracks” which have been conjoined together such that they may be treated as a single entity for the purposes of analysis or recommendation.

The terms “digital media catalogue”, “digital music catalogue”, “media catalogue” and “catalogue” are used interchangeably to indicate a collection of tracks and/or albums to which a user may be allowed access for listening purposes. The digital media catalogue may aggregate both digital media files and their associated metadata or, in another example embodiment, the digital media and metadata may be delivered from multiple such catalogues. There is no implication that only one such catalogue exists, and the term encompasses access to multiple separate catalogues simultaneously, whether consecutively, concurrently or by aggregation. The actual catalogue utilised by any given operation may be fixed or may vary over time and/or according to the location or access rights of a particular device or end-user.

The abbreviation “DRM” is used to refer to a “Digital Rights Management” system or mechanism used to grant access rights to a digital media file.

The verbs “to listen”, “to view” and “to play” are to be taken as encompassing any interaction between a human and media content, whether that be listening to audio content, watching video or image content, reading books or other textual content, playing a computer game, interacting with interactive media content or some combination of such activities.

The terms “user”, “consumer”, “end user” and “individual” are used interchangeably to refer to the person, or group of people making use of the facilities provided by the CloudStick. In all cases, the masculine includes the feminine and vice versa.

The term “CloudStick” is used to refer to any embodiment of the present invention, whether and howsoever it is attached to any computing device, including but not limited to a desktop computer, a laptop, an In-Vehicular Entertainment unit (IVE) or any other device.

The terms “device” and “media player” are used interchangeably to refer to any computational device which is capable of playing digital media content, including but not limited to MP3 players, television sets, home entertainment system, home computer systems, mobile computing devices, games consoles, handheld games consoles, IVEs or other vehicular-based media players or any other applicable device or software media player on such a device. Something essentially capable of playback of media. Where applicable, “device” may refer to the device alone or to the combination of the device and the CloudStick.

The verb “load”, in the context of transfer of files, is used to refer to the transfer of files from the device to the CloudStick using the CloudStick's “Connectivity to Device” interface and, where applicable, the appropriate logical interface to that component provided by, in the preferred embodiment, the CloudStick Agent. “Loaded files” are those files which are transferred using this mechanism.

### Architecture of the CloudStick

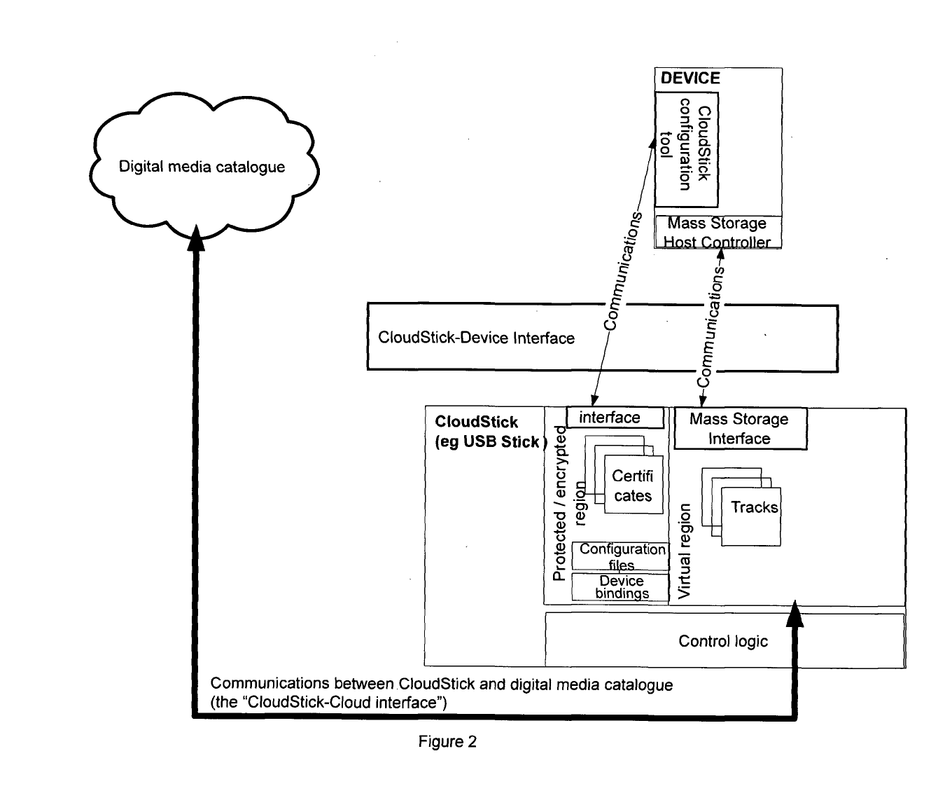

FIG. 2 illustrates the basic architecture, showing a simple example embodiment of the CloudStick which provides—in this example—two interfaces to the device.

The first such interface provides the device with a way by which the CloudStick may be configured for use with the device and the second interface provides the device with access to the digital media files supplied by the CloudStick. In another example embodiment, the two interfaces illustrated are physically or logically provided via any number of interfaces which serve the purposes described. In still another example embodiment, additional interfaces are provided which serve purposes in addition to that illustrated in FIG. 2. Such additional purposes are disclosed later in this document.

Also illustrated in the example embodiment in FIG. 2 is an on-device configuration tool, used to allow the device to be used to configure the operation of the CloudStick and/or the CloudStick Agent. While utilised in the preferred embodiment, this tool is not a fundamental requirement of the present invention but may be used to permit basic configuration or “tuning” of the operation of the CloudStick and/or the CloudStick Agent where such configuration is possible, appropriate and desirable.

For example, in one example embodiment the configuration tool is used to set details of the operation of a file system-style interface to configure whether non-nested lists of virtual files should be presented to the device as virtual files inside folders or as virtual playlist files. Details of this interface are disclosed in “The File System-Style CloudStick-Device Interface”, below.

### Storage

Also illustrated in the example embodiment in FIG. 2 is an example embodiment of the internal structure of the CloudStick, showing in this instance the control logic provided by the CloudStick Agent and two main storage areas:
A protected and/or encrypted store, used to hold DRM licences and keys, CloudStick configuration settings, device registration details, device bindings, digital media catalogue licensing or subscription files and any other files which are deemed either to be sensitive as to their content or non useful to be visible to the end user.
A store which holds the digital content being supplied to the device by the CloudStick and which is made available to the device via an appropriate interface supplied by the CloudStick Agent.
In the example embodiment illustrated, the interface provided is a Mass Storage Interface via a USB-based CloudStick, and which thus provides the device with an interface which permits the digital media content from the remote catalogue to be viewed as files/folders on what the device views as an external hard drive, as disclosed in detail below.

In one example embodiment, the storage areas are combined into a single storage area. In still another example embodiment, multiple storage areas are provided. In still other example embodiments, the storage area(s) provide either entirely encrypted or entirely unencrypted storage.

By providing the device with access to the digital media catalogue without the necessity of storing the entire catalogue's content on either the device or the CloudStick, the present invention effectively provides the device with the illusion that the storage capacity of the CloudStick is far greater than the physical storage capacity of the CloudStick, as disclosed in “Providing the Device with an interface to the Digital Media Content” below. Traditionally, approaches to this have provided the device only with locally-available content.

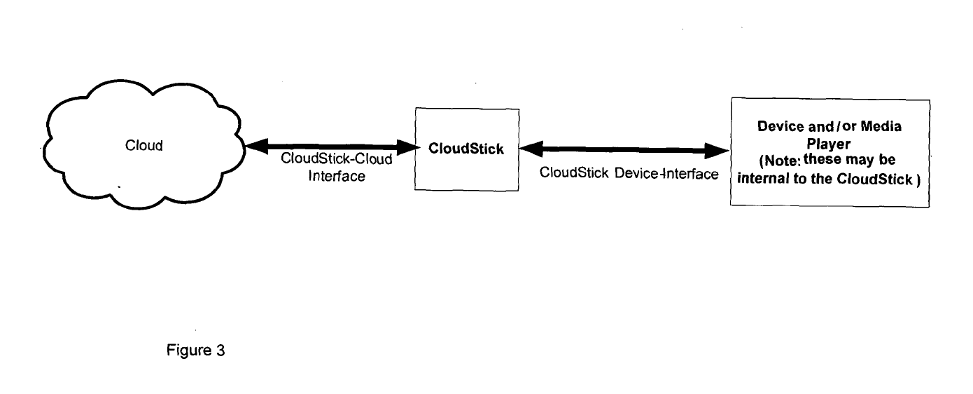

FIG. 3 illustrates the basic architecture of the CloudStick interfaces, showing that the CloudStick effectively acts, in the preferred embodiment, as a proxy (which may perform protocol mediation, as disclosed below) between the online “cloud” and the device to which the CloudStick is connected.

In one example embodiment, the CloudStick Agent intelligently reclaims storage space by identifying that digital media which was least-recently accessed/played and/or which the user (or his/her associated community, whether via social network rating or otherwise) has rated as being least popular and then deleting, archiving (moving to a separate storage device) or overwriting such media in order to utilise its storage space for more recently requested metadata or files. In this way, the apparent storage capacity of the CloudStick is further increased. In a further example embodiment, the mechanisms used to identify such reclaimable media content are as disclosed in Omnifone Patent Application Behaviour-Adaptive Synchronisation WO 2011/070366, the contents of which are incorporated by reference.

### The Media Player

The media player may be CloudStick-resident or device-resident. This component is used to play the digital media content. In the preferred embodiment, the media player is device-resident and its digital media content may be supplied from the CloudStick via an interface provided by the CloudStick Agent.

In another embodiment, the media player is CloudStick-resident and may be used to play digital media content which may be retrieved from the digital media catalogue via the CloudStick or which may be retrieved from the device or which may be loaded onto the CloudStick from one or more devices.

In the preferred embodiment, the CloudSticks acts as a proxy performing protocol mediation for the device and/or the media player, as where, for example, a streaming file is made to appear to the device as a local file.

### Communications Between the CloudStick and the Digital Media Catalogue: The CloudStick-Cloud Interface

As illustrated in FIG. 1 and in FIG. 3, the CloudStick, in the preferred embodiment, incorporates some form of online connectivity, referred to generally as the “CloudStick-Cloud interface”, in order to access the digital media catalogue for the purposes of one or more of the following:
In the preferred embodiment, register the CloudStick and/or the device with the digital media catalogue in order to obtain a license which permits the CloudStick/device/end-user to access that catalogue and its content
In the preferred embodiment, retrieve DRM license files, keys, Rights Objects or any other DRM data required to allow access to that digital media content which is protected by a DRM mechanism and to which access is permitted under the license and/or subscription associated with the CloudStick, the device and/or the end-user.
Query, search or otherwise browse the digital media catalogue
Access metadata from the digital media catalogue and/or any other aspects of a service to which the CloudStick's user is connected, such as user profiles, messages, recommendations, social network-related data, album listings, movie details, television schedules, theatrical listings, news and any other data made available via the CloudStick's connectivity.
Retrieve the digital media content, and any associated files which may be required to allow access to that content, from the digital media catalogue
Download, progressive download and/or stream digital media content from the digital media catalogue.
Perform any other reasonable communications between the CloudStick and the digital media catalogue, such as social networking functions and the making and obtaining of recommendations, playlists and so forth.
Access and/maintain subscription information and/or digital media content entitlements for the user or users of the CloudStick.
Allow synchronisation, whether manual or automatic, between the user's preferences and other metadata on the device and in the digital media catalogue. For example, where a user has created playlists of digital media content on a CloudStick-connected device then those playlists are, in the preferred embodiment, automatically kept synchronised with the user's data as held in or for the digital media catalogue. Another CloudStick registered to the same user is then, in the preferred embodiment, provided with the user's playlists, thus providing an automated (in the preferred embodiment) backup and restore of the user's data in case of loss, theft or damage and also enabling the user to utilise multiple CloudStick-enabled devices and keep his preferences and other data automatically synchronised across them all.
In one example embodiment, the online connectivity made available by the CloudStick is made available to the device for other uses, such as social networking functions and web browsing. In a further example embodiment, that online connectivity is made available only to specifically authorised applications on the device. In a still further example embodiment, such facilities are in addition, or instead, provided directly by the CloudStick Agent.

The actual CloudStick-Cloud interface may consist of any mechanism which provides access to the digital media catalogue and may constitute one or more of 2G, 2.5G, 3G, 4G, EDGE, Wifi, wireless LAN access, Bluetooth, 802.11a/b/g, LTE (3GPP Long Term Evolution), LTE Advanced or any mechanism which provides communications via any other wired or wireless communications protocol or method.

In one example embodiment, the CloudStick houses or otherwise utilises one or more active SIM (Subscriber Identity Module) cards, permitting it to authenticate to a mobile network and so make use of the MNO's (Mobile Network Operator) data connectivity. In a further example embodiment, multiple SIM cards are utilised to permit manual or automatic switching between MNO networks based on location, cost or any other considerations.

In the preferred embodiment illustrated, the online communications component is resident on the CloudStick. In another example embodiment, the online communications component is resident on the device to which the CloudStick is connected and is accessed by the CloudStick via the CloudStick-to-device communications component.

In the preferred embodiment, the CloudStick is provisioned with multiple means of obtaining access to the internet, with the CloudStick Agent utilising the most appropriate means of access based on the device's location, network availability, connection costs or any other appropriate metrics, in order to ensure that the digital media catalogue is accessible to the device if it is at all possible to connect to the internet.

Data retrieved via the online connection utilised or provided by the CloudStick may, in the preferred embodiment, be downloaded or streamed. In the preferred embodiment, digital media content may be buffered before being presented to the device, to ensure quality of playback.

Also in the preferred embodiment data—including digital media content, metadata, social networking data or any other retrieved data, as required—may be cached for future use, whether cached directly on the CloudStick or on some suitable alternative, such as Network Attached Storage or the device itself. Such cached data, in one example embodiment, may be used to provide the device with access to digital media content and/or associated metadata when “offline” (i.e. when online connectivity is unavailable, such as when travelling on some planes and underground railways).

### Communications Between the CloudStick and the Device: The CloudStick-Device Interface

Communication between the CloudStick and the device takes place via the “CloudStick-Device Interface” component of the CloudStick, as illustrated in FIG. 1 and in FIG. 3.

In the preferred embodiment, that physical component consists of one or more of the following:
a USB connection, and related technologies, such as mini-USB and micro-USB connections of whatever version
a Wireless USB connection
a Secure Digital card connection, including a CloudStick which is resident on an SD card or similar technology—such as an SDHC card, a MicroSD card, a MiniSD card, a Memory Stick or an SDIO (Secure Digital Input/Output) card
a wireless connection to the device, utilising WiFi, BlueTooth, a Wireless LAN or other wireless connections
an Ethernet cable
an eSATA connection
a mobile device connection such as an iPod™ or iPhone™ hub
a DLNA (Digital Living Network Alliance) capable interface
a DVI (Digital Video Interface) connection
a HDMI (High-Definition Multimedia Interface) connection
an infra-red or other non-visible light based interface
an IEEE 1394 (“FireWire™”, “i.Link™”, “Lynx™) interface
a smart card connection, such as an RFID interface or related wired or wireless technologies
any NFC (Near Field Communication) technologies, such as an RFID interface or related wireless technologies
any other mechanism which may be used to provide a communications facility between the CloudStick and the device and/or the media player.

The physical component(s) of the CloudStick-Device interface are provided with an appropriate logical interface using the CloudStick Agent, as disclosed below.

In another example embodiment, the CloudStick is connected with an interface to an old-style connector, such as a coaxial aerial connector or an audio input terminal. In this way, older devices which would not ordinarily be connectable immediately gain access to the digital media catalogue.

In another example embodiment, device-specific drivers may be present on the CloudStick and installed on the device, manually or automatically, on first connection of for example, a USB-based CloudStick to a home computer.

In still another example embodiment, the CloudStick is provisioned with multiple device interfaces, such as an “SD Plus” interface which provides both SD Card and USB connectivity.

In one example embodiment, the CloudStick connects with—or, in a further example embodiment replaces in part or in full—an in-vehicular entertainment (IVE) system to permit the IVE to access the digital media catalogue and/or any other CloudStick-supplied functionality disclosed herein within the vehicle, such as while driving a car.

### The CloudStick Agent

The CloudStick Agent is a software component which, in the preferred embodiment, is resident on the CloudStick. In another example embodiment, the CloudStick Agent is resident on the device. In still another example embodiment, the functions of the CloudStick Agent are apportioned between components resident on the CloudStick and other components resident on the device. In yet another example embodiment, components of the CloudStick Agent are duplicated across the CloudStick and one or more devices to which it is, directly or indirectly, connected.

The CloudStick Agent performs one or more of the following operations:
Communicating with the digital media catalogue as disclosed in “Communications between the CloudStick and the Digital Media Catalogue” above.
Querying the device to determine the appropriate interface to present to that device and providing the appropriate interface, as disclosed below.
Responding to queries from the device, such as USB interface queries
Supplying the device and/or the media player with digital media content and any other files or information required to play that digital media content from an online catalogue or locally-cached content or data

In one embodiment, the CloudStick Agent acts, when a connection exists, like an intelligent proxy. That is, the device does not know about the network but can make calls to the local API (Application Programming Interface) provided by the CloudStick Agent and the Agent then takes care of the connectivity and the proxying of requests to the remote digital media catalogue. In the preferred embodiment, the CloudStick in addition performed protocol mediation such that media content may be streamed to the CloudStick but presented to the device as if it were a locally stored file.

By means of the API provided by the CloudStick Agent, applications on the device—or, in another example embodiment, fully or partially resident on the CloudStick itself—may, in one example embodiment, make use of the CloudStick Agent's functionality and/or connectivity. All functionality accessible via the CloudStick API is also accessible internally by the CloudStick Agent itself in the course of its normal operation.

In that example embodiment, the CloudStick Agent's API (CSA-API) may be used to provide the device with access to more advanced access to the digital media catalogue, social networking services or any other services provided by the CSA-API.

In one example embodiment, the CSA-API permits the device to query the status and type of subscription provided by the CloudStick. In a further embodiment, the device is able to update that subscription status and/or carry out the purchasing of digital media content or other purchases, such as merchandise, concert tickets, movie theatre tickets, media or any other purchases—via the CSA-API provided.

In one example embodiment, the CSA-API allows the device to access offline content, such as digital media content and metadata which has been previously downloaded and cached, whether or not network connectivity is available. In a further embodiment, that cached content is made available to the device whether it is cached on the CloudStick, on the device or on some other mechanism, such as a Network Attached Storage system.

In one example embodiment, the CSA-API allows the device to perform a “sweep” of any digital media content stored on the device, uploading that content or descriptors thereof into the “cloud”, from which is may, in a further embodiment, be made available to the user's other registered devices. In a further embodiment, the parameters, scope, configurability and/or extent of that sweep may be determined by the user's subscription type and/or status with some service—for example, one subscription type may permit all content from each of the user's devices to be “swept into the cloud” while another subscription type may permit only one of the user's devices to be so swept.

In one example embodiment, the CSA-API allows the device to query or browse the digital media catalogue via the CloudStick Agent, rather than (or in addition to) utilising the standard interface presented to the device by the CloudStick. A further embodiment allows some or all of the disclosed features of the CloudStick Agent to be so accessed via the CSA-API by any permitted application, whether resident on the CloudStick or on the device.

In one example embodiment, the CSA-API may be used to transcode digital media content—that is, to convert a given media file from one format or specification or quality to another. In a further example embodiment, that transcoding is performed in real time as the content is played. In still a further example embodiment, that transcoding is performed to convert the media content from one of a given set of reference formats into some format required by the device which is being utilised to playback that media content.

In one example embodiment, the CSA-API allows the CloudStick and/or its associated device(s) to access to some or all of the digital content on some other CloudStick. On a further embodiment, the other CloudStick is one with which the CloudStick is associated. In a still further embodiment, the said access to media content on the other CloudStick is restricted according to one or more of the user's subscription types or statuses, the DRM-defined rules for content sharing and access, user preferences of the users associated with one or both CloudSticks or any other applicable restrictions.

In one example embodiment, the CSA-API permits media to be broadcast to one or more suitable media playback devices. In a further embodiment, such broadcast is performed wirelessly. In still a further embodiment such broadcast is performed to one or more DLNA-capable devices.

In one example embodiment, the CSA-API permits the synchronisation of the user's existing media collection on one or more devices (and/or their attached storage) with the user's media collection as defined on a service to which the user's CloudStick is linked. In a further example embodiment, the user's existing media content is identified using mechanisms disclosed in Omnifone Patent Application “Behaviour-Adaptive Synchronisation” WO 2011/070366, the contents of which are incorporated by reference.

In the preferred embodiment, the CloudStick Agent and the associated CSA-API provides the device with access to one or more of the features disclosed in the example embodiments given above. In still a further example embodiment, the device is provided with access to all of the aforementioned features via either or both of the CloudStick Agent and the CSA-API.

In the preferred embodiment, the CloudStick Agent is modular in architecture and consists of core capabilities, the minimum of which is the ability to identify, download and install, update or remove additional sub-systems or “plug-ins” for itself, including the entire CloudStick Agent software. In a further preferred embodiment, the CloudStick Agent API may be utilised to perform such activities, which may in themselves expand the capabilities of that CSA-API.

Providing the Device with an Interface to the Digital Media Content

In the preferred embodiment, the CloudStick Agent automatically queries the CloudStick-Device interface on the CloudStick to determine how the CloudStick is connected to the device and, specifically, what the capabilities of that CloudStick-Device interface are.

The interface presented to the device is then automatically tuned to provide an interface which the device is able to utilise. In another example embodiment, the device is presented with one or more possibly-suitable interfaces and the device is able to select, manually or automatically, which interface to utilise. In still another example embodiment, the interface presented is fixed according to the device, or type of device, with which the CloudStick is intended to work.

In the case of a USB-based CloudStick, the querying process, in the preferred embodiment, determines the version of the USB protocol which may be utilised by the device and presents a different CloudStick-Device interface depending on which version is available, like so:
Where the available version is able to handle HDMI, a HDMI interface is presented
Where the available version is able to handle streaming of digital content, a streaming interface is presented
Where the available version expects the device to see a file system then a file system-style interface is presented, as disclosed below.

In addition to presenting an interface to the device which differs according to the type and capabilities of the available physical CloudStick-Device interface, the CloudStick Agent also, in another example embodiment, varies the interface presented according to the type of digital media file(s) available. For example, in that example embodiment, a HDMI interface may be presented for HD-quality video files but a streaming interface for lower quality files and a file system-style interface for music files. Where multiple interfaces are available, the CloudStick, in its preferred embodiment utilises the most capable such interface.

In the preferred embodiment, the precise functionality available to the device via the interface provided also varies according to the capabilities of the CloudStick-Device interface and the device. Some examples of functional restrictions on this basis are illustrated in FIG. 3.

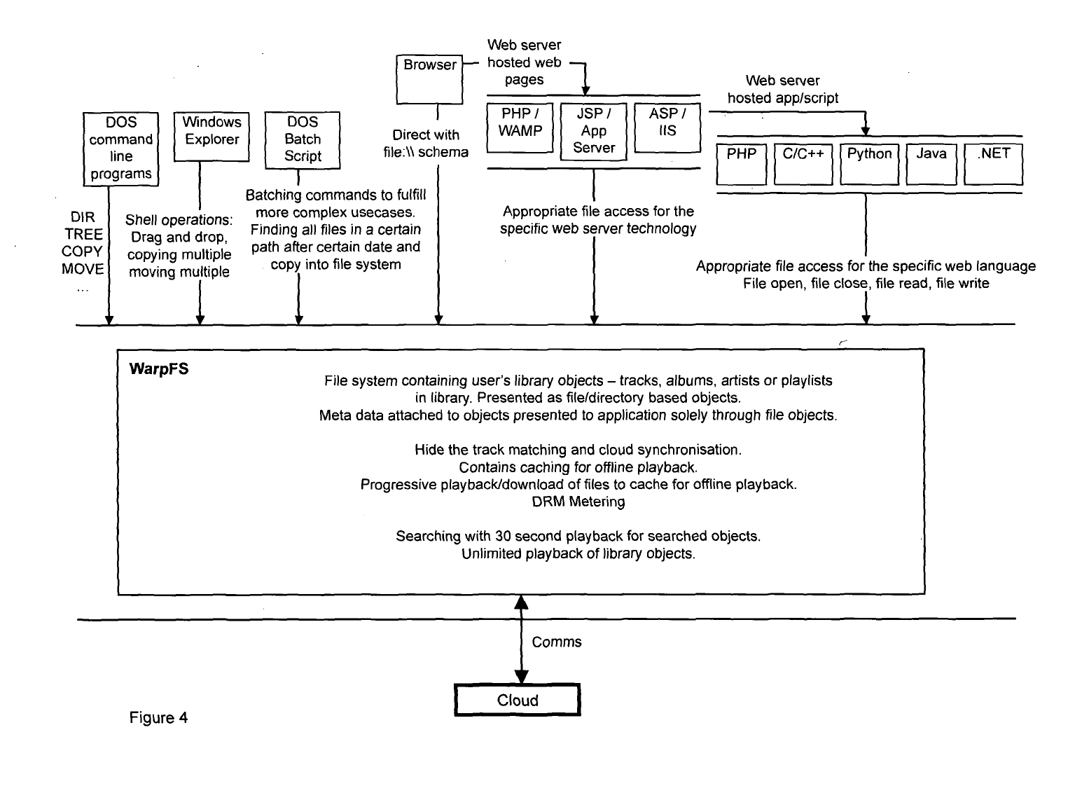

FIG. 4 shows examples of Functional Variations of File System Interface by Device/Access Type. WARP is a protocol (Web Accelerated Restful Protocol) deployed in the MusicStation platform from Omnifone; reference may be made to various public domain documents from Omnifone describing WARP, the contents of which are hereby incorporated by reference. An example document includes www.omnifone.com/UploadedFiles/Omnifone%20-%20WARP1pdf.

By presenting an interface appropriate to the specific device, the CloudStick permits the addition of connectivity—in the preferred embodiment, allowing access to a remote digital media catalogue—to any device which has a USB, Smart Card, media stick or any other compatible interface from which to read digital content files and/or browse and navigate the digital media catalogue. In some example embodiments, the selection of CloudStick-Device interface may be initiated by the CloudStick Agent itself or via its associated API (Application Programming Interface), either by the device or media player or via commands received from an authorised remote server.

### The File System-Style CloudStick-Device Interface

In the preferred embodiment, the CloudStick is able to—where appropriate, as determined by the CloudStick Agent's interrogation of the CloudStick-Device interface, as disclosed above—present a file system-style interface to the device. In another example embodiment, the interface presented to the device is tailored such that it is an interface known to be accessible by that device or type of device.

In the preferred embodiment, this consists of the results of querying the digital media catalogue being presented to the device as a faux file system of folders and/or files. Thus, the device is presented with a selection of digital content files, perhaps categorised into folders and/or playlist files, while having access to the entire digital media catalogue, as disclosed below. Such files and folders appear to the device as normal files and folders, as the device expects to view on a standard storage system to which that device is able to be connected.

For example, suppose that the end-user performs a search for albums, artists or tracks containing a specific phrase in their title or of a particular genre. Suppose also that the CloudStick-Device connection requires that the CloudStick present digital media content in the form of a file system, such as that presented by a USB hard drive.

In this circumstance, the search results provided via the CloudStick Agent to the device/media player could be presented as a folder on the CloudStick which, when accessed by the device, is found to contain virtual files.

Those virtual files may be actual digital media content files which have previously been downloaded, loaded or otherwise stored on the CloudStick. Or they may be placeholder files which, when accessed by the device, signal to the CloudStick Agent to download that digital media content and supply it to the device once downloaded (and, in the preferred embodiment, indicate to the device and/or media player that the digital media content represented by that virtual file is being downloaded and so may not be immediately available to play).

It is important to note that, from the perspective of the device, the files and folders made available to it via the CloudStick appear to be standard files and folders of the kind that the device is able to access normally.

In the preferred embodiment, when the device attempts to access such files or folders, the CloudStick Agent retrieves the desired information—whether that consists of additional metadata, such as an album listing for an artist, or actual digital media content, such as an eBook, a video or music content—from the digital media catalogue and makes that visible to the device in the form of files or folders.

In the preferred embodiment, the CloudStick Agent makes digital content available to the device only after confirming that the user has access rights, via a subscription or a purchase or any other appropriate means, to that digital content.

Again, from the device's perspective any network calls and access rights checks are performed invisibly: the device sees only files and folders of the type which would ordinarily be visible as though the digital media content and/or its associated metadata were physically present on an mass storage device accessible by the device.

Similarly, playlists of digital media content may be represented to the device as virtual folders “containing” the digital media content in that playlist. And similarly also for other groupings of digital media content such as genres, eras, artists, albums, releases and so forth.

In the same manner, sub-categories—for example, albums by artist—may be presented to the device as sub-folders. For example, a query to view the works of a particular film director by genre may produce nested categories which are presented to the device as nested folders, resulting in—for example—a virtual file with the path of “John Carpenter/Science Fiction/Dark Star” which, when accessed by the device or media player will download the movie “Dark Star” via the CloudStick Agent and play it on the device.

In the preferred embodiment, such “dynamic navigation” may be simulated by dynamically creating the folders based on logic resident within the CloudStick Agent or its associated API or based on queries of the digital media catalogue.

In another example embodiment, playlists and other non-nested groupings of digital media files are presented to the device and/or media player as playlist files appropriate to that device and/or media player. For example, rather than presenting the device with a folder containing virtual files and/or sub-folders containing other virtual files as the interface to an albums-by-an-artist listing, the albums may instead, in this example embodiment, be presented as playlists of virtual files, with the same basic functionality being triggered on access as is disclosed above.

Where the CloudStick-Device interface requires a file system interface to the CloudStick but is capable of streaming media then accessing the virtual file may, in the preferred embodiment, trigger the streaming of the digital media file to the device or media player rather than, or in addition to, downloading that digital media file. Similarly, in another example embodiment progressive downloading and/or file buffering may be employed where appropriate.

In another example embodiment, the virtual file system is in addition used as a command interface to the CloudStick whereby the creation of specific files and/or folders acts as a trigger causing the CloudStick Agent to query the digital media catalogue appropriately.

For example, in that example embodiment, the creation of a folder “Paul Simon” inside the “Search/Artists” folder tree on the CloudStick would trigger a search for tracks/albums/releases by that artist, with the search results appearing, in one example embodiment, as folders and/or virtual files inside the “Paul Simon” folder created, directly or indirectly, by the user.

In one example embodiment, the media collection of another user of a social networking service may be presented to the device as a “folder” with that user's name or similarly identifying mark, such as “My friends' Playlists” or “What Fred has listened to since Tuesday” or any reasonable queries.

In anther example embodiment, control information such as configuration options, subscription details, digital content entitlements, purchases or service- or user-specific metadata may be similarly presented via the file system interface, in a similar manner to the search example disclosed above.

In still another example embodiment, other social networking or other online data may be made available, either via the “file system” interface presented to the device and/or via the CloudStick API functionality disclosed above. For example, the current Facebook™ status of the user's friends may be listed as one or more files in a form which is readable by the device, such as a virtual ePub format file which, when accessed via an eBook reading device, is seamlessly updated with the user's friends Facebook™ status updates by the CloudStick Agent before that file is made openable by the device. In this way, dynamic data may be given to the user by presenting that dynamic data to the device as if it was static data.

### Pre-Licensing

In the preferred embodiment, CloudSticks are able to be pre-licensed, providing immediate “out of the box” access to a given digital media catalogue and/or connectivity via a given network, such as the network of a specific MNO (Mobile Network Operator).

Such pre-licensed CloudSticks may be obtained and immediately connected to a device and/or a media player and the end-user has immediate access to the specified digital media catalogue via the specified network.

In one embodiment, the license provided with the CloudStick is restricted to a given locale, territory, area or media catalogue. In another example embodiment, multiple licenses are provided with a single pre-licensed CloudStick and which license(s) are active may be manually selectable. In the preferred embodiment, one or more licenses are supplied with a pre-licensed CloudStick and the selection of which license is active at any given time is performed automatically with reference to one or more of the CloudStick or device's location, the availability connectivity, the availability or accessibility of associated media catalogue(s) or any other reasonable criteria.

In another embodiment, connectivity licenses such as one or more active SIM cards required to access the data network of particular Mobile Network Operators (MNOs), are pre-licensed for use with the CloudStick.

In the preferred embodiment, the CloudStick arrives “out of the box” with all necessary subscriptions, entitlements and connectivity licenses pre-purchased for, and included in the price of the CloudStick.

### Additional Optional Components

In addition to the central features of the CloudStick disclosed above, the CloudStick may also, in various example embodiments, also possess additional hardware or software capabilities, including zero, one or more of the following:
Headphone sockets, to permit—for example—the CloudStick Agent to function as a media player which is self-contained and connected
A battery, with a charging mechanism
A screen to display information to the end-user and/or to display images, text and/or video or any combination thereof
Operating controls for an on-CloudStick media player
Remote controls for an on-device media player. In one example embodiment, the CloudStick comprises a remote control device which, in addition to remotely controlling the media player wirelessly, also provides the online access to the digital media catalogue from which it retrieves digital media content to play on that media player.
A GPS or other mechanism for locating the position of the CloudStick and/or the device. In one example embodiment, the location of the CloudStick is used to determine which locale-specific digital media catalogue is to be accessed and to obtain access to that catalogue if desired. In another example embodiment the CloudStick may be used to automatically, or on request, purchase or otherwise obtain access rights to that catalogue.
A wifi connection to an external storage unit, such as a laptop or an NAS (Network-Attached Storage device) such that items downloaded to the CloudStick are, automatically or on request, moved or backed up to that storage device. In one example embodiment, older files are automatically moved to an NAS device as the CloudStick's storage starts to approach its capacity, thus making the CloudStick appear to be able to contain far more digital content than it can actually store internally. In another example embodiment, such files are automatically retrieved from the archive cache on the NAS device, rather than being re-downloaded, on access via the CloudStick in order to both increase the apparent storage capacity of the CloudStick and to improve the responsiveness of the system.
The capability to send and/or retrieve digital media files and/or associated metadata from other CloudSticks, thus permitting the establishment of a network of CloudSticks which are able to connect to one another in the same way that an individual CloudStick is able to connect to the digital media catalogue and/or the device.
The capability to upload media files to a networked and/or online “cloud” storage facility, thereby enabling the user to access their uploaded digital media in addition to, or instead of the digital content made directly available via the digital media catalogue.
The ability to Synchronise playback between multiple devices all calling for media services from one or more CloudSticks. For example, a user who is playing a particular track in his car might choose to link his CloudStick to one in his home. Once he enters his living room the same music track would, automatically or with little user input, start streaming to his living room device, perhaps starting from the same point in the track at which the in-car CloudStick or the same CloudStick left off.
The ability to function as a removable or Network Attached storage device and/or to interface with other such storage devices.
The facility to scan and identify media content on a device or removable storage and sweep such media content, or its descriptors, into the cloud.
The ability to verify the user's subscription status so that offline playback rights are correct so that, when online, the user receives the correct level of service.
Allow synchronisation, whether manual or automatic, between the user's preferences and other metadata on the device and in the digital media catalogue. For example, where a user has created playlists of digital media content on a CloudStick-connected device then those playlists may be automatically kept synchronised with the user's data as held in or for the digital media catalogue. Another CloudStick registered to the same user may then be provided with the user's playlists, thus providing an automatic backup and restore of the user's data in case of loss, theft or damage and also enabling the user to utilise multiple CloudStick-enabled devices and keep his preferences and other data automatically synchronised across them all.

Provides an intelligent caching system such that information cached locally by the CloudStick is prioritised according to the user's determined preferences and/or the type of data. For example, digital media content accessed more often by the user, or highly rated by the user, would be cached in preference to less frequently accessed or lower rated content. The using mechanisms disclosed in Omnifone Patent Application “Behaviour-Adaptive Synchronisation” WO 2011/070366, the contents of which are incorporated by reference, or any other appropriate mechanism, may be used to prioritise which data to cache locally.

1. A microprocessor based system for providing a media player with access to remotely-stored digital media content and/or its associated metadata (collectively, the “content”) whereby (a) the system is capable of accessing the content; (b) the media player is provided, by the system, with a suitable interface, accessible by that media player, for interacting with the content.

2. The system of claim 1, wherein the media player is connected to a network, the media player is not connected to a network or the media player is intermittently connected to a network.

3. The system of claim 1, wherein the suitable interface presented to the media player consists of one or more of the following, or some combination thereof:
a USB connection, and related technologies, such as mini-USB and micro-USB connections of whatever version, whether or not presented as a Mass Storage Interface to the media player;
a Wireless USB connection;
a Secure Digital card connection or similar technology, such as an SDHC card, a MicroSD card, a MiniSD card, a Memory Stick or an SDIO (Secure Digital Input/Output) card;
a wireless connection to the media player, utilising WiFi, BlueTooth, a Wireless LAN or other wireless connections;
an Ethernet cable;
an eSATA connection;
a mobile media player connection such as an iPod™ or iPhone™ hub or any other appropriate connection;
a DLNA (Digital Living Network Alliance) capable interface;
a DVI (Digital Video Interface) connection;
a HDMI (High-Definition Multimedia Interface) connection;
an infra-red or other non-visible light based interface;
an IEEE 1394 (“FireWire™”, “i.Link™”, “Lynx™) interface;
a smart card connection, such as an RFID interface or related wired or wireless technologies;
any NFC (Near Field Communication) technologies, such as an RFID interface or related wireless technologies;
any other mechanism which may be used to provide a communications facility between the system and the media player.

4. The system of claim 1, wherein the suitable interface presented to the media player includes a coaxial aerial connector or an audio input terminal or any other suitable connection, whether analogue or digital.

5. (canceled)

6. The system of claim 1, wherein the selection as to which interface(s) to present to the media player is made automatically based on the capabilities of the media player—whether those capabilities are detected by the system or retrieved via a lookup of the media player's capabilities based on identifying information about the media player, however obtained or retrieved—or by any other suitable criteria.

7. The system of claim 1, wherein the system accesses the content via one or more of: a direct connection, a wireless connection, such as wifi; a wireless network; a mobile network; an internet connection; 2G, 2.5G, 3G, 4G, EDGE, Wifi, wireless LAN access, Bluetooth, 802.11a/b/g, LTE (3GPP Long Term Evolution), LTE Advanced or any mechanism which provides communications via any other wired or wireless communications protocol or method.

8. (canceled)

9. The system of claim 1, wherein the selection as to which method of connectivity to use by the system to access the content is determined automatically based on connection strength, tariff costs, location, connection speed or by any other suitable criteria.

10. The system of claim 1, wherein the system houses or otherwise utilises one or more active SIM (Subscriber Identity Module) cards to permit the system to authenticate to a mobile network and so make use of the MNO's (Mobile Network Operator) data connectivity.

11. The system of claim 1, wherein the system houses or utilises multiple SIM cards and switches between different mobile network operators, whether that switching is performed manually, at user instigation or automatically, based on location, tariffs or any other considerations.

12. (canceled)

13. The system of claim 1, wherein the content is made available via a digital media content subscription service AND the system is capable of registering or logging into that service if required.

14. The system of claim 1, wherein the system accesses and/or maintains subscription information and/or digital media content entitlements for the user or users of the system with regard to the service or services with which the system is registered and/or connected to.

15-16. (canceled)

17. The system of claim 1, wherein the system allows synchronisation, whether manual or automatic, between the user's preferences and/or any other associated metadata on the system and in the digital media catalogue.

18. The system of claim 1, wherein the online connectivity provided by the system is made available to the media player and/or to the system for other purposes, such as social networking functions and web browsing, whether generally or only to specifically authorised applications.

19. The system of claim 1, wherein the system contains a protected and/or encrypted store, used to hold one or more of: DRM licences and keys, system configuration settings, system registration details, system bindings, digital media catalogue licensing or subscription files and any other files which are deemed either to be sensitive as to their content or non-useful to be visible to the end user or which are stored in that protected store for any other reason.

20. (canceled)

21. The system of claim 1, wherein the system acts as a proxy or a protocol mediation proxy between one or more online digital media collections and the media player to which the system is connected.

22. The system of claim 1, wherein content—including digital media content, any associated metadata, social networking data or any other retrieved data, as required—is cached for future use, whether cached directly on the system or on some suitable alternative, such as Network Attached Storage or the media player.

23. The system of claim 1, wherein cached data is used to provide the system with access to content and/or associated metadata when “offline” (when online connectivity is unavailable), such as when travelling on some planes and underground railways or when connectivity is disabled, whether manually or automatically.

24. The system of claim 1, wherein the system intelligently reclaims storage space by identifying that content which was least-recently accessed/played and/or which the user (or his/her associated community, whether via social network rating or otherwise) has rated as being least popular and then deleting, archiving (moving to a separate storage system) or overwriting such media in order to utilise its storage space for more recently requested metadata or files.

25. The system of claim 1, wherein the media player communicates with the system via an Application Programming Interface (API) provided by the system to the media player for that purpose.

26-38. (canceled)

39. The system of claim 1, wherein the system is a portable, personal device.

40. The system of claim 1, wherein the system microprocessor is not dedicated to the system but used by other processes or modules that are unrelated to the system.

41. The system of claim 1 which is self-contained in so far as it has own dedicated microprocessor and operating system.

42. The system of claim 1 which is adapted to operate with the media player, in which the media player has no intrinsic ability to access remotely stored content.

43. The system of claim 1 which is adapted to operate with the media player, in which the media player has no intrinsic ability to access remotely stored content and is a legacy third party media player.

44. (canceled)

45. The system of claim 1 which is packaged as a USB memory stick.
